(19) United States
(12) Patent Application Publication
(10) Pub. No.: US 2012/0148757 A1
(43) Pub. Date: Jun. 14, 2012

(54) METHOD FOR MANUFACTURING LIGHT GUIDE PLATE

(75) Inventors: Kentarou HYAKUTA, Niihama-shi (JP); Hideyuki YAMADA, Fukui-shi (JP); Hidekazu SHIOMI, Fukui-shi, Fukui (JP)

(73) Assignees: SEIREN CO., LTD., Fukui-Shi (JP); SUMITOMO CHEMICAL COMPANY, LIMITED, Tokyo (JP)

(21) Appl. No.: 13/313,547

(22) Filed: Dec. 7, 2011

(30) Foreign Application Priority Data
Dec. 9, 2010 (JP) 2010-274902

(51) Int. Cl. B05D 5/06; B29C 71/04

(52) U.S. Cl. 427/541; 427/164

(57) ABSTRACT

A method for manufacturing a light guide plate includes the step of printing a dot pattern with ink droplets on a surface of a transparent resin sheet while the transparent resin sheet is conveyed continuously or intermittently, and forming reflective dots from the dot patteren. The ink droplets are supplied from a plurality of nozzles fixedly arranged across a width direction of a region of the surface of the transparent resin sheet where the reflective dots are formed.

### BACKGROUND OF THE INVENTION

1. Field of the Invention

The present invention relates to a method for manufacturing a light guide plate.

2. Related Background Art

A transmission-type image display device such as a liquid crystal display generally includes a surface light source device as a backlight. The edge-light type surface light source device is comprised of a light guide plate having a transparent resin sheet and a light source supplying light to an end surface of the transparent resin sheet. Light incident from the end surface of the transparent resin sheet is reflected by a reflecting means such as reflective dots provided on a rear surface of the transparent resin sheet, so that planar light for image display is supplied from an emission surface of the light guide plate.

As a method for forming reflective dots (reflective printing), an ink jet printing method has been suggested (Japanese Patent Laid-Open No. Hei-9-68614). According to the ink jet printing method, reflective dots constructing a desired pattern are expected to be easily formed.

### SUMMARY OF THE INVENTION

An object of the present invention is to provide a method enabling stable manufacturing of a light guide plate including reflective dots with higher productivity.

The present invention relates to a method for manufacturing a light guide plate including a step of printing a dot pattern with ink droplets on a surface of a transparent resin sheet while the transparent resin sheet is conveyed continuously or intermittently, and a step of forming reflective dots from the dot pattern. In the method according to the present invention, the ink droplets are supplied from a plurality of nozzles fixedly arranged across a width direction of a region of the surface of the transparent resin sheet where the reflective dots are formed.

Since the plurality of nozzles for supplying the ink droplets are fixedly arranged across the entire width direction of the region of the surface of the transparent resin sheet where the reflective dots are formed, the transparent resin sheet can be printed with ink substantially at a stroke across its entire width direction. Accordingly, it is not necessary that the nozzles are scanned in the width direction of the transparent resin sheet. Thus, the light guide plate can be stably manufactured with sufficiently high productivity.

It is preferable that the ink droplets are discharged from the plurality of nozzles by an ink jet method. According to the ink jet method, a pattern with fine reflective dots can be easily formed.

The plurality of nozzles may be connected to a single ink tank storing the ink. Thus, one type of ink for forming the reflective dots can be effectively used for printing while the fineness of the ink in the width direction is adjusted as necessary.

It is preferable that the ink is a solventless ink or a water-based ink in view of environmental measures. It is preferable that the ink is a radiation curable ink that cures by radiation like or electron beam in view of efficiency of production. Especially, a solventless UV curable ink is preferable.

It is preferable that the transparent resin sheet is a polyalkyl(meth)acrylate resin sheet, a polystyrene sheet, or a polycarbonate-based resin sheet. Thus, light emitted from a light source can be effectively utilized.

It is preferable that the transparent resin sheet contains diffusing particles to easily improve the uniformity of light emitted from the light guide plate. Since the uniformity of light can be improved and the reflective dots can be made less likely visible from an image display side, it is preferable that a surface opposite to the surface of the transparent resin sheet where the reflective dots are formed is concavity and convexity surface.

### BRIEF DESCRIPTION OF THE DRAWINGS

FIG. 1 is a cross-sectional view showing an embodiment of a transmission-type image display device including a surface light source device.

FIG. 2 is a perspective view showing an embodiment of a method for manufacturing a light guide plate.

### DESCRIPTION OF THE PREFERRED EMBODIMENTS

A preferred embodiment of the present invention will be explained below in detail. However, the present invention is not limited to the embodiment.

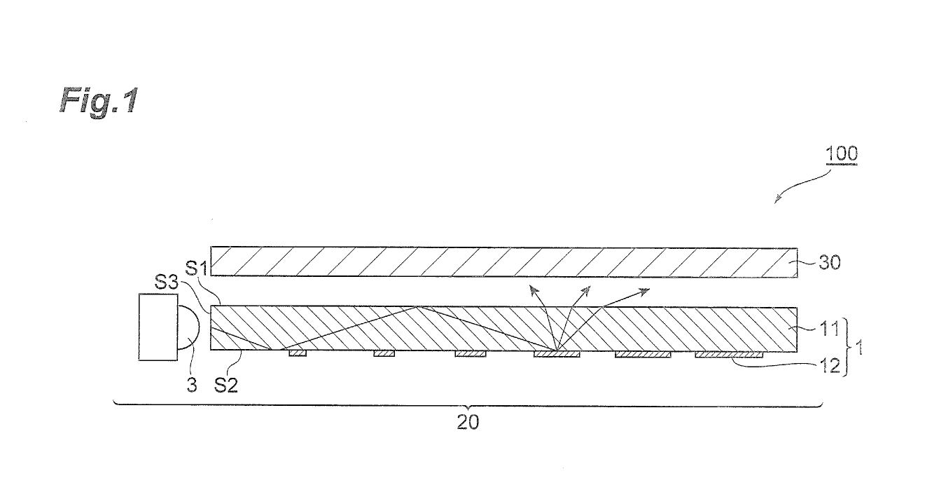

FIG. 1 is a cross-sectional view showing an embodiment of a transmission-type image display device including a surface light source device. The transmission-type image display device 100 shown in FIG. 1 is mainly comprised of the surface light source device 20 and a transmission-type image display 30. The surface light source device 20 is an edge-light type surface light source device including a light guide plate 1 having a transparent resin sheet 11 and a light source 3 provided along an end surface 53 of the transparent resin sheet 11. The transparent resin sheet 11 has an emission surface S1 and a rear surface S2 opposite thereto. The light guide plate 1 further includes reflective dots 12 on the rear surface S2 side. The transmission-type image display 30 is disposed to face the light guide plate 1 on the emission surface S1 side of the light guide plate 1. For example, the transmission-type image display 30 is a liquid crystal display having liquid crystal cells.

Light emitted from the light source 3 enter the transparent resin sheet 11 through the end surface S3. The light entered the transparent resin sheet 11 is diffusely reflected by the reflective dots 12 to be emitted mainly from the emission surface S1. The light emitted from the emission surface S1 is supplied to the transmission-type image display 30. The pattern of the reflective dots 12 is adjusted so that planar light is uniformly emitted from the emission surface S1 effectively. The adjacent reflective dots 12 may be separated from each other, or connected to each other.

It is preferable that the transparent resin sheet 11 is a polyalkyl(meth)acrylate resin sheet, a polystyrene sheet, or a polycarbonate-based resin sheet. It is preferable that the transparent resin sheet 11 contains diffusing particles. The surface (the emission surface S1) opposite to the surface (the rear surface S2) on which the reflective dots 12 of the transparent resin sheet 11 are formed can be a flat surface as in the embodiment. However, it is also preferable that the emission surface S1 is concavity and convexity surface.

The light source 3 can be a linear light source such as a cold cathode fluorescent lamp (CCFL). However, it is preferable that the light source 3 is a point light source such as LED. At this time, a plurality of point light sources are arranged along at least one side of four sides constructing a rectangular main surface of the transparent resin sheet 11.

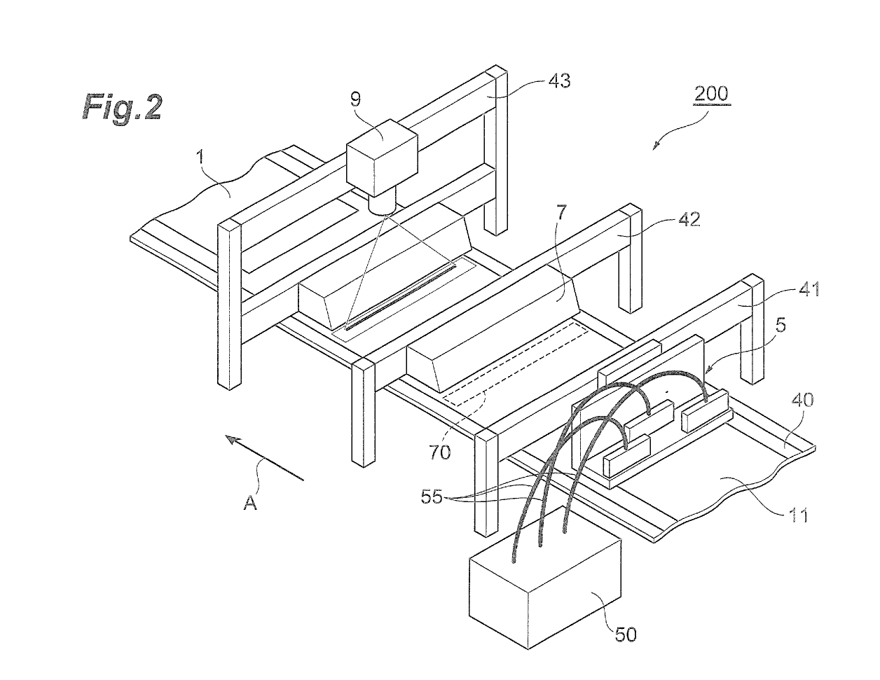

FIG. 2 is a perspective view showing an embodiment of a method for manufacturing a light guide plate. A manufacturing device 200 for manufacturing the light guide plate as shown in FIG. 2 are comprised of a conveying means 40 for conveying the transparent resin sheet 11, an ink jet head 5, a UV lamp 7, and an inspecting device 9. The ink jet head 5, the UV lamp 7, and the inspecting device 9 are arranged in this order from the upstream side in a conveying direction A of the transparent resin sheet.

The transparent resin sheet 11 is conveyed by the conveying means 40 in the direction A continuously or intermittently. The transparent resin sheet 11 may be cut in advance according to the size of the light guide plate to be manufactured, or may be cut after the reflective dots 12 are formed on the elongated transparent resin sheet 11. The conveying means 40 according to the embodiment is a table shuttle, but is not limited thereto. For example, the conveying means 40 may be a belt conveyor, roller, or air floating conveying means.

A dot pattern is printed on the surface of the transparent resin sheet 11 with ink droplets by the ink jet head 5 supported by a support 41. A plurality of dots printed with ink may be separated from each other, or connected to each other. The ink jet head 5 includes a plurality of nozzles fixedly arranged in one or more rows facing the rear surface S2 of the transparent resin sheet 11 across the width direction (direction vertical to the direction A) of a region of the surface of the transparent resin sheet 11 where the reflective dots are formed. The ink droplets are discharged from the plurality of nozzles according to an ink jet method at the same time so that the transparent resin sheet 11 is printed across its entire width direction at a stroke. Preferably, the transparent resin sheet 11 is continuously conveyed at a predetermined speed and is printed with ink. Alternatively, printing the transparent resin sheet 11 with ink in a state of stopping the transparent resin sheet 11, and then conveying the transparent resin sheet 11 to a next printing position and stopping it, can be repeated so that the transparent resin sheet 11 is effectively printed with ink in a pattern comprised of a plurality of rows of dots. A conveying speed of the transparent resin sheet 11 is adjusted so that the transparent resin sheet is appropriately printed with ink. In this embodiment, the ink jet head 5 is comprised of a plurality of units each having a plurality of nozzles. These units are disposed such that adjacent end portions are overlapped in the direction A where the transparent resin sheet 11 is conveyed. Alternatively, an ink jet, which has a plurality of nozzles arranged in series across the width direction of the region of the surface of the transparent resin sheet where the reflective dots are formed, may be used.

In this embodiment, the transparent resin sheet 11 can be printed with ink at a stroke across the entire width direction while the plurality of nozzles of the ink jet head 5 are fixed. Accordingly, the productivity of the light guide plate is remarkably improved as compared when the transparent resin sheet 11 is printed with ink sequentially while movable nozzles are scanned in the width direction of the transparent resin sheet 11. Especially, when a large light guide plate with a short side having the length of 200 mm or more and 1000 mm or less is manufactured, the productivity is efficiently improved according to the method of the embodiment. Further, according to the ink jet method, even fine reflective dots having the maximum diameter of 100 μm or less can be easily and accurately formed. When the transparent resin sheet is thin, the reflective dots may be transparent as viewed from the emission, surface S1 side. However, it can be prevented by downsizing the reflective dots. Also, the ink supplied by the plurality of nozzles can be connected to form large reflective dots.

The nozzles of the ink jet head 5 are connected to an ink supply unit 50 via conduits 55. For example, the ink supply unit 50 includes an ink tank storing the ink and a pump for sending the ink. The plurality of conduits 55 may be connected to a single ink tank, or may be connected to a plurality of ink tanks respectively.

It is only required that the ink can form reflective dots by curing or drying. For example, a UV curable ink, a water-based ink, or a solvent ink may be used. It is preferable that the ink is a solventless ink or a water-based ink in view of environmental measures. It is preferable that the ink is a radiation curable ink that cures by radiation like UV or electron beam in view of efficiency of production.

Especially, a solventless UV curable ink is preferable. When the UV curable ink is used, the ink is cured in a region 70 by the UV lamp 7 supported by a support 42. Accordingly, the reflective dots 12 consisted of the cured ink are formed. When the water-based ink or solvent ink is used, the ink is dried by a drier to form the reflective dots. Either ink may contain fine particles such as pigment, or may be transparent without fine particles as necessary.

Subsequently, the light guide plate 1 is obtained through a step for inspecting a state of the formed reflective dots 12 by the inspecting device 9 supported by a support 43. The light guide plate 1 is cut to a desired size as necessary. It is not required that the light guide plate is continuously inspected by the inspecting device provided on the downstream side of the ink jet head as in the embodiment. The light guide plate may be inspected off-line by an inspecting device provided separately. Alternatively, the step for inspecting the light guide plate using the inspecting device can be omitted.

According to the present invention, the light guide plate with the reflective dots can be stably manufactured at high printing speed with higher productivity. Also, printing variations in the width direction are not easily caused as compared a case where the transparent resin sheet is printed with ink while movable nozzles are scanned along the surface of the transparent resin sheet.

What is claimed is:

1. A method for manufacturing a light guide plate, comprising:
a step of printing a dot pattern with ink droplets on a surface of a transparent resin sheet while the transparent resin sheet is conveyed continuously or intermittently; and
a step of forming reflective dots from the dot pattern, wherein
the ink droplets are supplied from a plurality of nozzles fixedly arranged across a width direction of a region of the surface of the transparent resin sheet where the reflective dots are formed.

2. The method according to claim 1, wherein the ink droplets are discharged from the plurality of nozzles by an ink jet method.

3. The method according to claim 1, wherein the plurality of nozzles are connected to a single ink tank storing the ink.

4. The method according to claim 1, wherein the ink is a UV curable ink or a water-based ink.

5. The method according to claim 1, wherein the transparent resin sheet is a polyalkyl(meth)acrylate resin sheet, a polystyrene sheet, or a polycarbonate-based resin sheet.

6. The method according to claim 1, wherein the transparent resin sheet contains diffusing particles.

7. The method according to claim 1, wherein a surface opposite to the surface of the transparent resin sheet where the reflective dots are formed is an irregular surface.
